(19) United States
(12) Patent Application Publication
(10) Pub. No.: US 2007/0221430 A1
(43) Pub. Date: Sep. 27, 2007

(54) Modular automobile system and method

(76) Inventor: Kenneth M. Allison SR., Porter, TX (US)

Correspondence Address: THE MATTHEWS FIRM, 2000 BERING DRIVE, SUITE 700, HOUSTON, TX, 77057, US

(21) Appl. No.: 11/385,303

(22) Filed: Mar. 21, 2006

(51) Int. Cl. B60K 5/00

(52) U.S. Cl. 180/299; 180/312

(57) ABSTRACT

A modular motor vehicle system and method allowing a user replace modular components of the automobile wherein vehicle repair and replacement time is greatly decreased. The present invention is further incorporates built in speed control devices, built in fire suppression systems, flotation materials to keep motor vehicles from sinking in high water, as well as interlocking bumpers, controls, brakes, and accelerators for freeway and interstate travel. The present invention also cleans up the atmosphere as it is used.

### TECHNICAL FIELD

The present invention relates generally to the motor vehicle industry, and more specifically the present invention relates to an improved overall motor vehicle industry including manufacture and assembly, after sales parts/components, modular units, automobile servicing and after market replacement parts.

### BACKGROUND ART

One embodiment of the present invention is further meant to simplify the motor vehicle industry from the user/consumer standpoint as well and to extend the net life cycle of each motor vehicle unit built to consider the rising cost of replacement materials, and to consider the environment, from landfills, waste disposal, waste recycled fluids and materials. One embodiment of the present invention will also address built in speed control devices, built in fire suppression systems, flotation materials to keep automobiles, trucks and school buses from sinking in high water, as well as interlocking bumpers, controls, brakes, and accelerators for freeway and interstate travel. One embodiment of the present invention also cleans up the atmosphere as it is used.

### BRIEF DESCRIPTION OF DRAWINGS

FIG. 1 illustrates a side view partially in cross section of an automobile in accordance with present invention;

FIG. 2 illustrates two perspective views of the engine compartment attached to the frame/unibody and one with the engine compartment disengaged from the frame/unibody in accordance with present invention;

FIG. 3 illustrates a top view partially in cross section of an embodiment in accordance with present invention;

FIG. 4 illustrates a side view partially in cross section of an embodiment of the present invention in accordance with present invention;

FIG. 5 illustrates a perspective view and a partial blowout view of an embodiment in accordance with present invention;

FIG. 6 illustrates a top view partially in cross section of an embodiment in accordance with present invention;

FIG. 7 illustrates a flow chart of the engine computer signal reception in accordance with present invention; and

FIG. 8 illustrates a side view partially in cross section of an embodiment in accordance with present invention.

The drawings constitute a part of this specification and include various embodiments of the present invention, which may be embodied in various forms. It is to be understood that in some instances, various aspects of the invention may be shown exaggerated, reduced or enlarged, or otherwise distorted to facilitate an understanding of the present invention.

For a further understanding of the nature and objects of the present invention, reference should be had to the following detailed description, taken in conjunction with the accompanying drawings, in which like elements are given the same or analogous reference numbers.

### DETAILED DESCRIPTION OF THE PREFERRED EMBODIMENTS

Detailed descriptions of the embodiments are provided herein, as well as a mode of carrying out and employing embodiments of the present invention. It is to be understood, however, that the present invention may be embodied in various forms other than those specifically disclosed. Therefore, specific details disclosed herein are not to be interpreted as limiting, but rather as a basis for the claims and as a representative basis for teaching one skilled in the art to employ the present invention in virtually any appropriately detailed system, structure, or manner. The practice of the present invention is illustrated by the following examples which are deemed illustrative of both the process taught by the present invention and of the product and article of manufacture made in accordance with the present invention. It should also be noted that throughout this disclosure one or a plurality of clips, springs or other devices could be used as would be apparent to one skilled in the art.

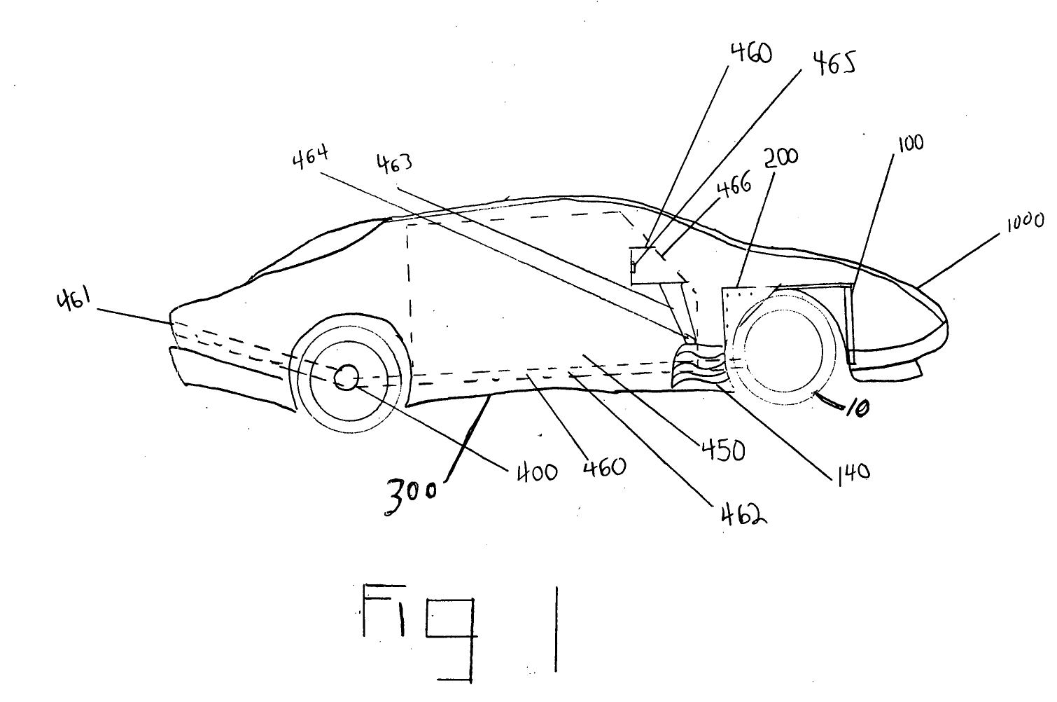

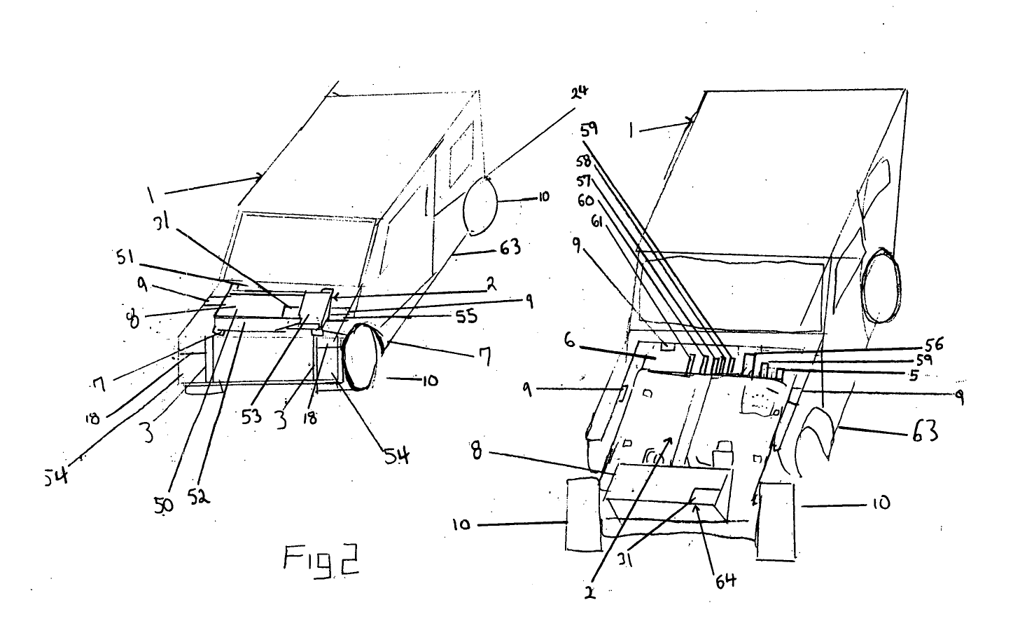

FIG. 1 illustrates one general embodiment of the apparatus as divided into at least six general modular components. It is important to not that one of ordinary skill in the art could see how to arrange these components into different subgroups or group the components together to form larger or smaller component blocks or modules as desired. It is also important to note that additional figures and disclosure will provide a more detailed description of the inventive apparatus' function. The front clips 100 are preferably located in the front of the vehicle 1000 and preferably in front of the wheels and on each side of the vehicle 1000. However, the exact location, of clips 100; may vary with design and should not be viewed as a limitation thereof. The front clips 100 are preferably designed to attach the motor and engine compartment components to the frame 300. The front clips 100 are preferably designed to be easily removable (preferably without the use of power tools) to allow for easy removal of the engine compartment. However, some tools may be required if the clips 100 further comprise belts or screws. It should be understood that the number of clips 100 should be minimized to facilitate quick attachment and/or removal. The engine compartment clips 200 are preferably located behind the engine compartment. The engine compartment clips 200 are preferably designed to attach to the back portion of the motor and engine compartment components to the frame 300. It is also to be understood that the engine compartment clips 200 may attach directly to the front clips 100 so as to add support to the engine compartment and also to allow for ease in detaching the engine compartment from the frame 300. The engine compartment clips 200 are preferably designed to be easily removable (preferably without the use of power tools) to allow for easy removal of the engine compartment (FIG. 2 discusses in more detail).

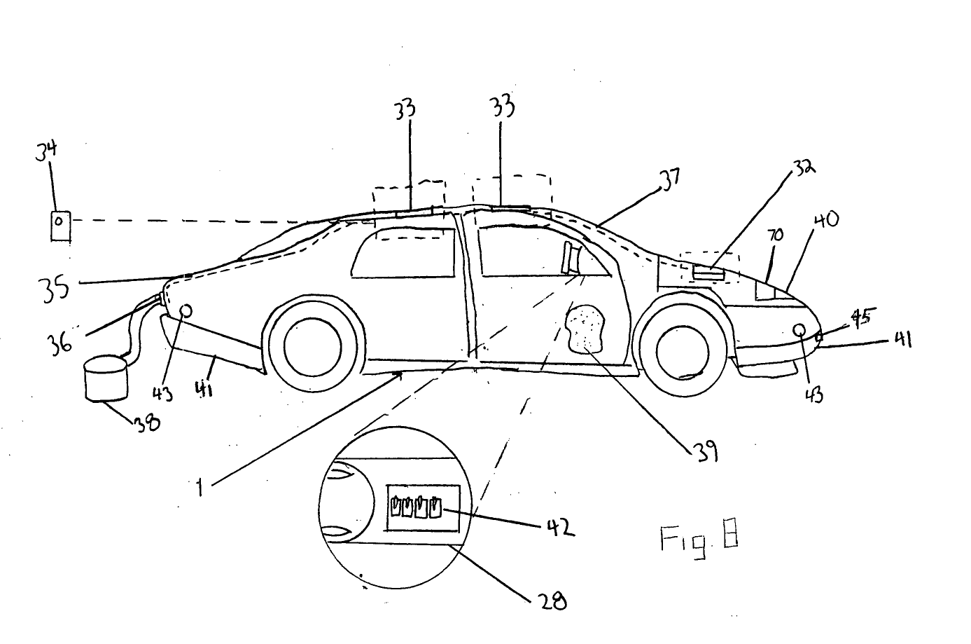

Also illustrated in FIG. 1 is one embodiment of an air filter system 140 (an alternate air filtration system is shown in FIG. 8). The air filter 140 is preferably designed to intake air and can be located on any position on the frame 300 or body so as to allow for air inflow into the air filter frame 140. As illustrated the air filter is attached to the front of the vehicle 1000, but behind front tires 10. The air filter 140 is preferably attached to a pipe system 460 which comprises air filters and purifiers 462 designed to clean the air passing through the pipe system 461 and purify it prior to the air leaving the pipe system 460 through the pipe system exit 461. The pipe system exit 461 is preferably designed to be in the rear of the vehicle so as to allow purified and filtered air to exit the vehicle. The air filters and purifiers 462 are known in the art and are designed to filter the air that moves through them and to remove harmful pollutants.

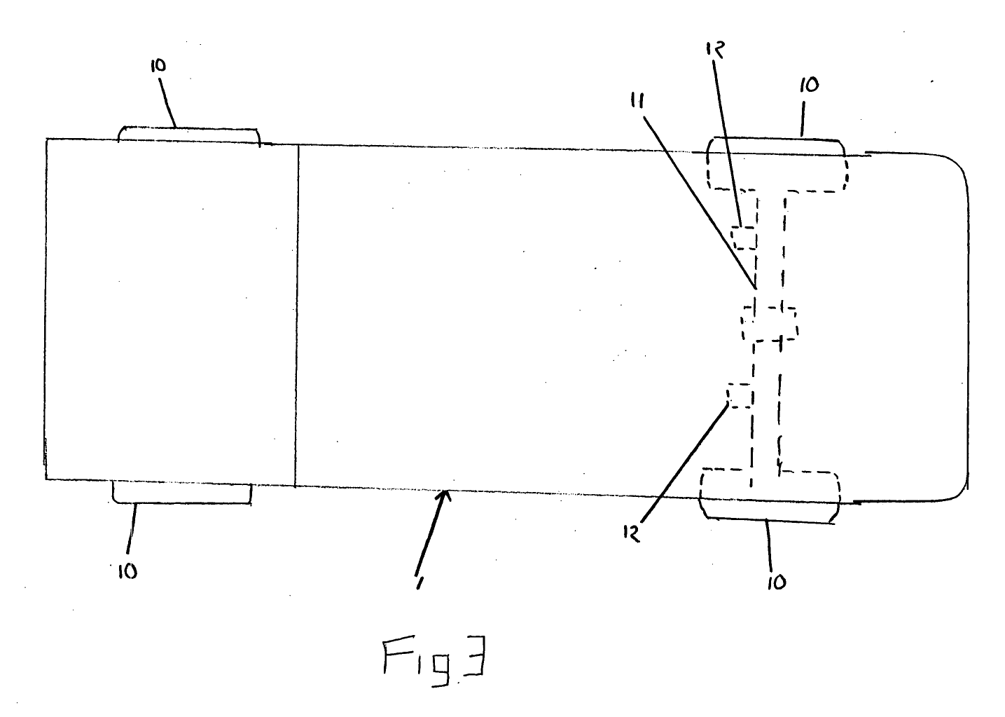

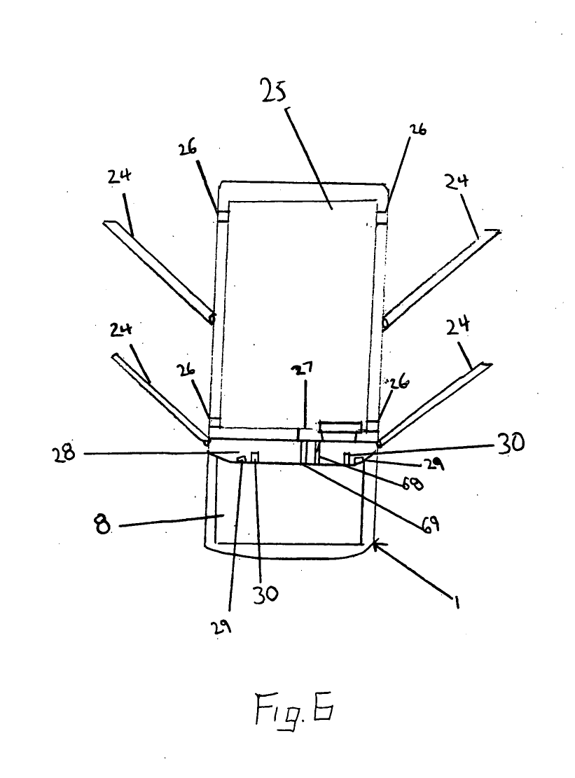

Also illustrated in FIG. 1 is the rear axle 400 of the vehicle 1000. The rear axle 400 is preferably constructed to be able to readily detach from the frame 300 in an expeditious manner similar to the front clips 100 such that the rear axle 400 can be quickly replaced. FIG. 3 further illustrates the detachment of the rear axle 400. The interior 450 of the vehicle is also preferably modular so that the interior 450 can quickly be detached from the from the frame of the vehicle and pulled out through a door 24 (FIG. 6). It should be understood that door 24 should either be fully opening (i.e. movement of at least more than ninety degrees or should be easily detachable to facilitate the removal of interior 450. FIG. 6 further illustrates the detachment of the interior 450. The dashboard 460 is also preferably a modular piece, which can be quickly removed from the vehicle. In one embodiment of the invention, the dash board column 463 is preferably attached to the frame 300 by preferably, but not limited to, a C-shaped coupler and bolt, a quick release mechanism pin, or other quick release mechanism 464 known in the art. In one embodiment of the invention, once the quick release 464 is disengaged the dashboard 460 and the dashboard column 463 can be removed from the frame 300 via a door 24. In an alternate embodiment of the invention, the quick release 464 is a C-shaped coupler that can be disengaged when the dashboard is pulled in a downward fashion therein putting the C-coupler 464 in a release position in relation to the bolt so that the C-coupler can then slide off the bolt and the dashboard 460 and dashboard column 463 can be removed by the vehicle. It is important to note that in the C-coupler embodiment a quick catch release 465 located preferably on the side or front of the dashboard 460 needs to be activated therein releasing the dashboard 460 from the dash portion of the frame 466 and allowing for the dashboard 460 and the dashboard column 463 to rotate about the bolt of the C-coupler 464.

FIG. 2 illustrates an embodiment of modular vehicle 1. Modular vehicle 1 can have any chassis styling such as, but not limited to, a truck, a bus, SUV, SUT, car, wagon, cab, van or mini-van, or other vehicle. Modular vehicle 1, as illustrated in FIG. 2 is a hatchback or hybrid SUV, but is in no way limited to this vehicle chassis. The modular vehicle 1 contains a main drive train 2, comprising, but not limited to, the motor 50, transmission 51, radiator 52 and battery 53. The main drive train 2 is preferably able to be installed or removed from the modular vehicle 1 as a single section or unit. The removal or installation of the main drive train 2 can be accomplished by removing the front clip quick disconnect 3, such as but not limited to the quick disconnect clips utilized in autoracing. Also attached in the quick disconnect 3 arrangement are the headlights 18, blinker 54 and horn 55 through a multiconductor wiring harness 5 located and attached to the frame/unibody 6. Once the multiconductor wiring harness 5 is disconnected from the frame/unibody 6, front switches/clips 7 (commonly referred to in the art as easy clips or zip clips) can be removed. The front switches/clips 7 are designed to keep the drive train 2 attached to the frame 63. Once the switches/clips 7 are removed, all of the quick connects such as, but not limited to, the transmission linkage 56, speedometer cable 57, brake lines 58, steering column for the gear box 59, throttle cable/rod 60, heater hoses 61, A/C compressor high pressure lines 62, and the multi-conductor wiring harness 5 for the engine compartment to the interior of the vehicle can be disconnected. Once the transmission linkage 56, speedometer cable 57, brake lines 58, steering column for the gear box 59, throttle cable/rod 60, heater hoses 61, A/C compressor high pressure lines 62, and the multi-conductor wiring harness 5 for the engine compartment to the interior of the vehicle have been disconnected the frame/unibody 63 can be separated such that the engine compartment 8 can be removed from the rest of the modular vehicle 1. The removal of the engine compartment 8 can be accomplished by pulling the disconnect pins 9, which may be but are not limited to disconnect pins, latches, catches, turnbuckles or a combination therein, from the main body frame 63. The engine compartment 8 can then be pulled away and/or rolled away from the frame 63 and be replace or repaired.

In one embodiment of the invention, the wheels 10 are preferably still intact on the drive train 2 so that the drive train 2 can be wheeled out of the frame as a complete unit, which preferably comprises, but is not limited to the engine, transmission, steering gear box (with steering components), shocks springs, sway bars, CV joints/drive axles, brakes, brake lines, hubs/discs, radiator, hoses, belts, batteries, and computer 64. Once the drive train 2 is pulled away from the frame 63 any of the aforementioned parts can then be replaced or repaired as needed as single parts or as an entire unit. The replacement units can be, but are not limited to, after market units, industry units, or high performance units. Hence, the quick changeability of engine compartments 8 and drive trains 2 will allow for a expedited engine block replacement for users who race their cars, who are going to utilize their cars for different functions such as touring versus towing, or users that need their vehicles repaired. The ease of replacement of the engine compartment 8 would also allow for manufacturers to mass produce engine compartments 8 and drive trains 2 for car repair facilities to store on site. Therein potentially driving down replacement part costs. It is further envisioned that the engine compartments 8 and drive trains 2 could be removed by specially trained mechanics at local stations possibly called “drive-thru's” in which a consumer can schedule an appointment with the mechanics, then bring the car to the “drive-thru” and have the entire drive train 2 or engine compartment 8 changed out in possibly under one hour.

FIG. 3 illustrates an alternate and/or additional embodiment of the apparatus. If a user wanted the rear drive axle/spindles 11 changed or repaired there is preferably a quick disconnect 12, such as, but not limited to, a hinged bracket with a bolt or bolts, a latch or catch pin, or a series of multiple pins/bolts/bushings 12 attaching the rear drive axle/spindle 11 to the drive shaft 2 (in the case of a front wheel drive vehicle it would not actually attach to the drive shaft). In order to access the hinged bracket with a bolt or bolts, a latch or catch pin, or a series of multiple pins/bolts/bushings 12 the modular vehicle 1 would need to be raised (not shown). Once the modular vehicle 1 is raised a user or mechanic need only to disengage the hinged bracket with a bolt or bolts, a latch or catch pin, or a series of multiple pins/bolts/bushings 12. Once the hinged bracket with a bolt or bolts, a latch or catch pin, or a series of multiple pins/bolts/bushings 12 the rear drive axle/spindle 11 can be disengaged and removed from the modular vehicle 1.

It should be noted that all of the embodiments mentioned in the specification can apply to types of motor vehicles utilized. It should also be noted that vehicle safety could potentially be improved by mandating an engine compartment 8 replacement based on vehicle years of use and vehicle mileage. It should also be noted that in removing the drive shaft 2 of many vehicles various lifting equipment as used in the art may be needed to support the frame 63.

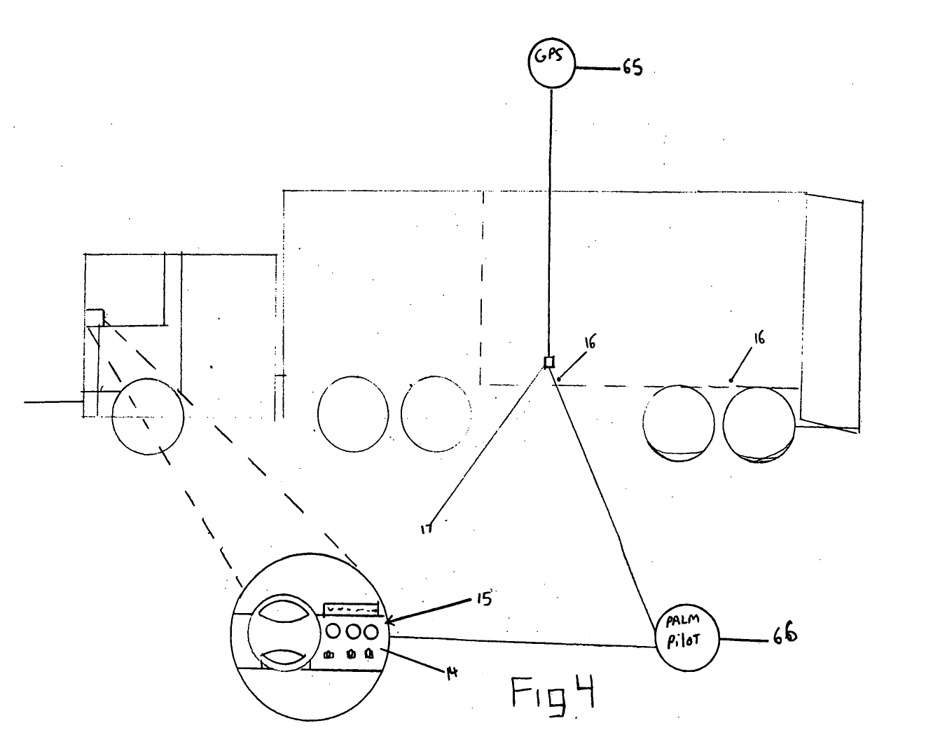

As illustrated in FIG. 4, in one embodiment of the apparatus, there are sensors and smart monitoring devices 14 designed to input varying data into the modular vehicle's dashboard computer and display 15. The dashboard computer and display 15 is designed to utilize standard equipment known in the art for computerized vehicular display. The smart monitoring device can be, but is not limited to, a keypad, a touch screen, or voice activated. In trucks or other vehicles, (FIG. 4) sensors 16 may be utilized to indicate to the driver or an end user if the truck is loaded, overloaded, the load weight and load distribution. This information is relayed to the smart monitoring 14 and is inputted and displayed on the dashboard computer and display 15 as is know in the art. If the truck is loaded or being loaded when the engine is running then the sensors 16 can send a signal to the monitoring devices 14 which will be displayed on the dashboard computer and display 15 indicating this condition and/or the sensor can send a signal to the engine computer 31 directly to shut down the engine. Also preferably located in the truck bed or cab is another sensor 17 which provides GPS information which is linked to a standard GPS monitoring system 65. This sensor 17 coupled with the sensor 16 will enable a driver or other end user of monitoring the load condition, location and status of the vehicle, therein enhancing safety. The sensors 14 and 17 may also receive data from hand held computer devices such as, but not limited to, a palm pilot 66, wherein the data may comprise, but is not limited to information concerning the user's license status, insurance or operator status of a particular vehicle. If the driver is not authorized to utilize the vehicle in question, the dashboard computer and vehicle display 15 may restrict the user from starting the vehicle by sending a signal to the engine computer 31 shutting down or preventing the engine compartment 8 from starting. If the vehicle is reported stolen or the vehicle is tipped on its side then the sensor 17 can report the vehicles location to a remote user via GPS 65 to indicate the need for emergency help or to track the stolen vehicle.

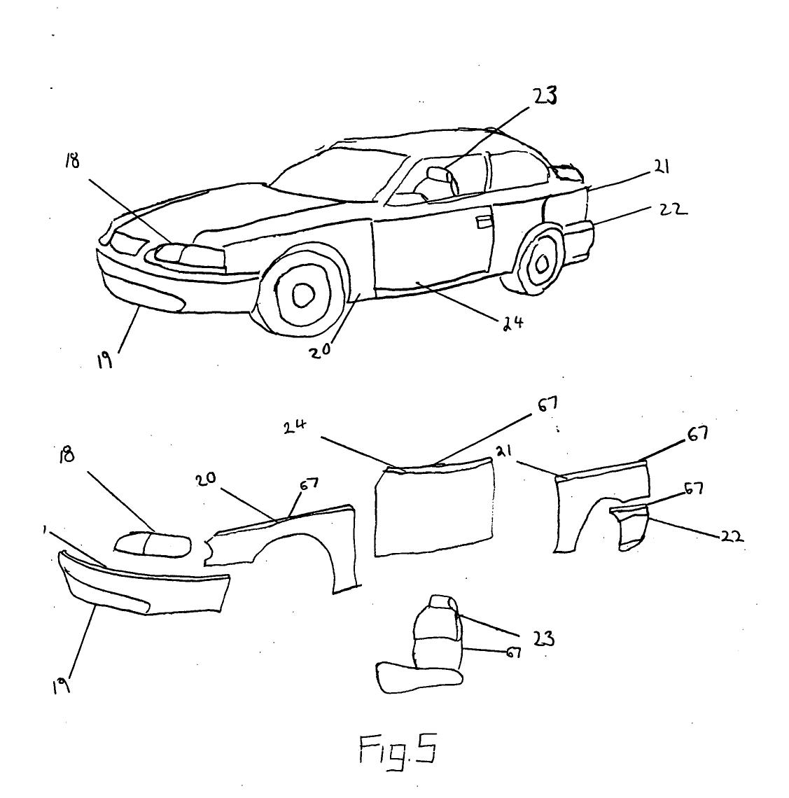

FIG. 5 illustrates a vehicle with the quick exchange parts in a partial blow out view. The attachments for all of these removable parts is preferably, but not limited to the removal of wingnuts, clips, or other attachment devices known in the art. The headlights 18 are preferably constructed so as easily come out of the frame for quick replacement. The front bumper assembly 19, the front quarter panel or fender 20, the rear quarter panel 21, and the rear bumper 22 also are designed for quick removal. All of the parts shown in FIG. 5 may optionally be equipped and lined with flotation materials 67 so as to assist the modular vehicle 1 in passing through high water or in case of a flood emergency. It should be appreciated that when the floatation equipped vehicle is a bus, many lives could be saved should a bus, such as a school bus, drive into deep water. Further the floatation may also delay the sinking of a vehicle until all passengers can evacuate the vehicle. Another potential use of the flotation material 67 is that it may assist in absorbing impact in the case of an accident. The seat 23 is preferably equipped with flotation materials as well and is preferably easily removable from the modular vehicle 1. It should be noted that a plurality of seats may be present in the modular vehicle 1.

FIG. 6 illustrates how to remove certain interior elements of the apparatus (not shown is the seats (FIG. 5)). The door 24 are preferably easily removed via removal of the wingnuts or other attachment devices known in the art. The doors 24 are preferably attached to the frame 63 in such a fashion that the doors 24 can rotate greater than 90 degrees from the frame 63 upon full rotation. The interior of the modular vehicle 1 can preferably be changed as easily as the exterior. The head liner 25 of the modular vehicle 1 can be removed by pushing the roof support 26 either in or out and then taking the head liner 25 out of the modular vehicle 1. The inspection plate 27, near the steering wheel, can also be removed in a manner well known in the art. After the removal of the inspection plate 27, the gear shift 68, emergency brake connect 69 and wiring harness 5 leading to the engine compartment 8 can be disconnected. Upon disconnecting the wiring harness leading to the engine compartment 8, the dash board 28 can be removed by releasing the latches 29 on each side of the underside of the dash board 28. Upon release of the latches 29, the dash can lean forward and be lifted off the supports 30 and removed from the modular vehicle 1. New versions of each of the aforementioned parts of FIG. 6 or repaired versions of the aforementioned parts can then be put into the modular vehicle 1.

It should be appreciated that the modularity concept, described herein, may be adapted to a variety of vehicles including, but not limited to, land, sea, or air vehicles. In particular the racing industry may adapt many of the concepts described herein. For example, not intended as limiting, the modular vehicle will allow cars damaged in races or qualifying race preliminaries to be easily and quickly repaired and put back in the race. The various speed controls could be used to reduce the speed of all cars during certain flagged occasions.

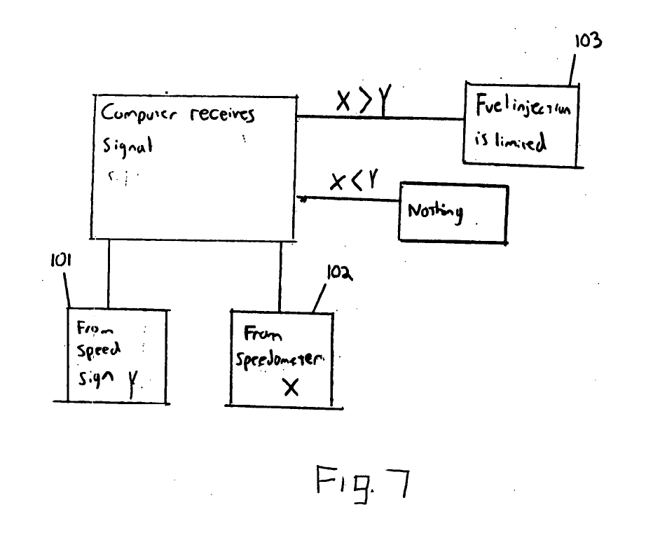

FIG. 7 illustrates a flow chart indicating the types of signals that can be received by the engine computer 31 (FIG. 2). The engine computer 31 can receive signals from speed limit signs, high water signs, ice on bridge signs or a whole host of other signs posted throughout the roadways 101. The computer can also receive signals from the speedometer, indicating the speed of the vehicle 102. If the speed of the modular vehicle 1 exceeds the posted speed limit, the computer 31 can signal the fuel injector to limit the fluid being injected into the engine and hence slow down the vehicle 103. Alternatively, the computer 31 can receive a signal from a law enforcement agent or other end user directing the computer 31 to limit or stop the fluid being injected into the engine, therein slowing down the modular vehicle 1 or stopping it entirely. It is also envisioned that in the alternative, parents can program the computer 31 to not exceed a certain speed, acceleration, or RMP and that upon exceeding one of these set parameters the computer 31 will signal the fluid injector to limit the fuel injected into the engine. In conjunction with sensor 17, a vehicle computer 31 could also be programmed so that flashers would activate if the motor vehicle is taken out after a certain time, for example midnight. The activated flashers would signal to the proper law enforcement authorities that a juvenile had procured the vehicle and was using it after-hours. In addition to activating flashers or horn or disabling a vehicle, the vehicle computer 31 can also communicate with a GPS system to alert parents or vehicle owners as to the location of the vehicle and its recent operational history. It is also envisioned that the speed control can be used to maintain a preferred distance between automobiles. In this embodiment, one or more sensors 45 could be mounted on the front bumper 41 (FIG. 8) or elsewhere on the automobile. The sensors 95 will preferable sence and/or calculate the distance to the next automobile in front. If the detected distance is less than a predetermined amount the vehicle will automatically stop or slow down. This feature would be very useful in heavy traffic or when a vehicle cuts in front of another to prevent or minimize the damage from rear end collisions.

FIG. 8 illustrates the fire suppression system in one embodiment of the apparatus. Illustrated is the under the hood fire suppression system 32 and the cab fire suppression system 33. The under the hood fire suppression system can be a two stage system capable of firing twice to smother out flames. The system would preferably be activated by the presence of active flames, or heat above a certain temperature. The hood fire suppression system 32 should also be interlocked with the fuel system to shut off the fuel either mechanically or electrically in the case of a vehicle fire. The cab fire suppression system 33 should be able to be triggered inside the modular car 1 by either the user through the dashboard and computer display 15 or by a remote user such as a fireman through the use of a remote control 34. It is also envisioned that there will be a tube system 35 running through the frame of the modular vehicle 1 wherein the tube system 35 preferably attached to portals 36 where a user such as a fireman can attach a hose to pump in a fire fighting agent 38 such as, but not limited to, water or foam. The tube system 35 preferably has channels 37 leading to the engine compartment 8 and the passenger compartment such that when the fire fighting agent 38 is introduced in the tube system 35 then the agent 38 is released into the engine compartment 8 and the passenger compartment therein preferably putting out the fire. It should be noted that the application of the tube system 35 could also be applied to any vehicle, such as but not limited to trucks, airplanes or helicopters, as well as dwellings.

Additionally, in one embodiment of the apparatus an electrostatic skin 39 is applied to the exterior of the vehicle to collect air born pollutants. Alternatively, or in addition to this skin 39 a filter 40 may be added in front of the radiator 70, wherein the filter 40 would also collect air borne pollutants. The filter 40, is preferably designed to be washable and to last the life of the radiator 70. The filter 40 may also be sprayed with a spray commonly used with motorcycle dirt bikes to enhance the life and performance of the filter 40.

FIG. 8 further illustrates an alternate embodiment of the apparatus in which electromagnetic bumpers 41 would be attached to the modular vehicle 1. The electromagnetic bumpers 41 could be activated and deactivated by the user by flipping a series of switches 42 located on the dash board 28. The electro magnetic bumpers 41 are preferably constructed to be able to alternate between a negative and a positive magnetic dipole as dictated by the switches 42 activated on the dash board 28. It is also preferable that the switches 42 would also be linked to a signaling lights 43 on the front and back of the modular vehicle 1 to indicate that the electromagnetic bumpers 41 are activated and which charge the electromagnetic bumper 41 is currently running.

It is envisioned that one potential use for the electromagnetic bumper 41 is to create a series of linked cars on a highway, similar to the linkings of a train. The linked cars could potentially cut down on gas consumption and pollution. In order to join the linked cars, a modular car 1 would need to activate the electromagnetic bumper 41 and then attach, magnetically, to the rear bumper of the vehicle in front of him. It is envisioned that the braking and drive systems of all vehicles in the linked car chain would be synchronized when the modular vehicles 1 are linked, therein increasing safety and improving gas mileage. The linkage could occur by having the dashboard computer and display 15 for the various modular vehicles sending and receiving signals from each other in which the vehicle operations would be coordinated. In order to disengage from the linked car chain, a user need only to deactivate the electromagnetic bumpers 41, wherein the magnetic attraction is gone. The modular vehicle 1 is then free to drive independently of the linked car chain. It is also envisioned that another use for the electromagnetic bumpers 41 would be to actively repel other modular vehicles 1. In this way, a user could switch the polarity of the electromagnetic bumper to a negative charge if the user perceived that another driver was driving recklessly and had their electromagnetic bumper charged to a negative charge. Since like poles repel the two vehicles would then be likely avoid a collision or lessen the impact if one occurred due to magnetic repulsion.

It may be seen from the preceding description that a new and improved system modular automobile system and method of use has been provided. Although very specific examples have been described and disclosed, the embodiment of one form of the apparatus of the instant application is considered to comprise and is intended to comprise any equivalent structure and may be constructed in many different ways to function and operate in the general manner as explained hereinbefore. Accordingly, it is noted that the embodiment of the new and improved system and method described herein in detail for exemplary purposes is of course subject to many different variations in structure, design, application, form, embodiment and methodology. Because many varying and different embodiments may be made within the scope of the inventive concept(s) herein taught, and because many modifications may be made in the embodiments herein detailed in accordance with the descriptive requirements of the law, it is to be understood that the details herein are to be interpreted as illustrative and not in a limiting sense.

I claim:

1. A motor vehicle apparatus comprising:
a plurality of modular units attached to a central frame or unibody;
said modular units further comprising a main drive train module, and a rear axle module;
an engine frame with a disconnectable front end housing the main drive train module;
a rear drive frame with a disconnnectable rear end housing the rear axle drive module;
said main drive train module further comprising a motor, transmission, radiator and battery; and
said rear axle module further comprising axle, tires, bearings, brakes, hubs, rotors, springs, shocks, and sway bars, wherein
said main drive train module can be removed from the engine frame by disconnecting the front end of the engine frame and sliding, rolling, or lifting the main drive train module forward and said rear axle module can be removed from the rear drive frame by disconnecting the rear end of the rear drive frame and sliding, rolling or lifting the rear axle module backward.

2. The apparatus of claim 1 further comprising:
a harness attached to the main drive train module consisting of an element selected from the group of:
a transmission linkage, speedometer cable, brake lines, steering column from the gear box, throttle cable wire or rod, heater hoses, an air conditioning compressor, and combinations thereof.

3. The apparatus of claim 1 wherein the main drive train module further comprises:
a steering gear box, shocks, drive axles, tire rods, steering links, brakes, radiator, batteries and engine computer.

4. The apparatus of claim 3, wherein
said motor vehicle is a truck;
said truck further comprises a cab and a trailer;
said trailer comprises an interior storage area;
said interior storage area further includes sensors capable of indicating if the storage area is overloaded and relaying said information to the engine computer, wherein
said engine computer can activate or deactivate the motor based on sensor information.

5. The apparatus of claim 4, wherein
said sensors are capable of relaying location information to a GPS system.

6. The apparatus of claim 1 further comprising:
a plurality of doors attached to the central frame, wherein
said doors are detachable from the frame.

7. The apparatus of claim 1 further comprising:
body materials attached to the frame or unibody;
said body materials consisting of an element selected from the group of:
fenders, door panels, quarter panels, seating, or a combination therein,
said body materials are lined with flotation materials, wherein
said flotation materials will retard or stop the motor vehicle apparatus from sinking in liquid conditions.

8. The apparatus of claim 1 further comprising:
a fluid injection system attached to the motor;
said fluid injection system further comprising a fluid injection regulator, wherein
the fluid injection regulator is designed to regulate fluid injected into the engine and thereby regulate the speed of the motor vehicle apparatus.

9. The apparatus of claim 8 further comprising:
sensors attached to the fuel injection system to receive signals external from the vehicle;
wherein said external signals signal the fuel injection regulator to regulate fluid injected into the motor and thereby regulate the speed of the motor vehicle apparatus.

10. The apparatus of claim 1 further comprising:
sensors attached to the central frame, wherein
said sensors are capable of relaying location information to a GPS system.

11. The apparatus of claim 1 further comprising:
a fuel system attached to the motor;
a fire suppression system;
said fire suppression system further comprising a unit fired by an operator and a unit which shuts off the fuel system attached to the motor.

12. The apparatus of claim 1 further comprising:
a body;
an air filtration system attached to the radiator and/or engine and/or body, whereby
the air passing through the radiator and/or engine and/or body is filtered.

13. The apparatus of claim 1 further comprising:
an interior compartment;
the interior compartment further comprising a seat, a dash board, a steering wheel, and a head liner, wherein
the seat, dash board, steering wheel, and head liner can be disconnected and removed from the interior compartment.

14. The apparatus of claim 1 further comprising:
a bumper attached to the central frame;
said bumper further comprising a magnet;
said magnet further comprising an active and inactive mode, whereby
when said magnet is activated it is capable of attracting and attaching to a magnet on another bumper of a motor vehicle apparatus, wherein the motor vehicles will become attached.

15. The apparatus of claim 14 further comprising:
deactivating the magnets therein detaching the motor vehicles.

16. The apparatus of claim 14 further comprising:
repolarizing the magnets so that like polarized motor vehicles repel each other.

17. A method for creating a modular motor vehicle comprising:
attaching a plurality of modular units to a central frame;
comprising the modular units of a main drive train module, a rear drive axle module;
housing the main drive train module within an engine frame with a disconnectable front end;
housing the rear axle drive module within a rear drive frame with a disconnnectable rear end;
comprising said main drive train module of a motor, transmission, radiator, CV-joints, axles, tie rods, steering links, computer, tires, wheels and battery; and
comprising said rear drive axle module of a complete axle, tires, bearings, brakes, hubs, rotors, springs, shocks and sway bars;
removing said main drive train module from the engine frame by disconnecting the front end of the engine frame and sliding or lifting the main drive train module forward; and
removing said rear axle drive train module from the rear drive frame by disconnecting the rear end of the rear drive frame and sliding, rolling or lifting the rear axle drive train module backward.

18. The method of claim 17 further comprising:
attaching a quick disconnect harness to the main drive train module, wherein
said harness consisting of an element selected from a group of:
a transmission linkage, speedometer cable, brake lines, steering column from the gear box, throttle cable or rod, heater hoses, an air conditioning compressor, and combinations thereof.

19. The method of claim 17 further comprising:
comprising the main drive train module with a steering gear box, shocks, drive axles, brakes, radiator, batteries and engine computer.

20. The method of claim 19 further comprising:
providing said motor vehicle as a truck;
providing said truck with a cab and a trailer;
providing said trailer with an interior storage area;
providing interior storage area further with sensors capable of indicating if the storage area is overloaded and relaying said information to the engine computer, wherein
activating or deactivating the motor based on sensor information relayed to said engine computer.

21. The method of claim 20 further comprising:
relaying location information to a GPS system through said sensors.

22. The method of claim 17 further comprising:
attaching a plurality of detachable doors to the central frame.

23. The method of claim 17 further comprising:
attaching body materials to said frame or unibody;
selecting body materials from an element of the group of:
fenders, door panels, quarter panels, seating, or a combination therein,
lining said body materials with flotation materials, wherein
retarding or stopping the motor vehicle apparatus from sinking in liquid conditions via use of the floatation materials.

24. The method of claim 17 further comprising:
attaching a fluid injection system to the motor;
attaching a fluid injection regulator to said fluid injection system, wherein
regulate the speed of the motor vehicle apparatus via the fluid injection regulator which is designed to regulate fluid injected into the engine.

25. The method of claim 24 further comprising:
attaching sensors to the fuel injection system to receive signals external from the vehicle;
signaling the fuel injection regulator to regulate fluid injected into the engine and thereby regulate the speed of the motor vehicle apparatus via said external signals.

26. The method of claim 17 further comprising:
attaching sensors to the central frame, wherein
relaying location information to a GPS system through said sensors.

27. The method of claim 17 further comprising:
attaching a fuel system to the motor;
providing a fire suppression system;
comprising the fire suppression system further of a unit fired by an operator and a unit which shuts off the fuel system attached to the motor.

28. The method of claim 17 further comprising:
providing a vehicle body;
attaching an air filtration system to the radiator and/or engine and/or a body;
filtering the air passing through the radiator and/or engine and/or a body.

29. The method of claim 17 further comprising:
providing an interior compartment;
comprising the interior compartment of a seat, a dash board, a steering wheel, and a head liner, wherein
disconnecting and removing the seat, dash board, steering wheel, and head liner from the interior compartment.

30. The method of claim 11 further comprising:
attaching a bumper to the central frame;
providing the bumper with a magnet capability;
comprising said magnet with an active and inactive mode, whereby
activating said magnet so to be it is capable of attracting and attaching to a magnet on another bumper of a motor vehicle apparatus, wherein the motor vehicles will become attached.

31. The apparatus of claim 30 further comprising:
deactivating the magnets therein detaching the motor vehicles.

32. The apparatus of claim 30 further comprising:
repolarizing the magnets so that like polarized motor vehicles repel each other.
